(19) United States
(12) Patent Application Publication
(10) Pub. No.: US 2014/0164963 A1
(43) Pub. Date: Jun. 12, 2014

(54) USER CONFIGURABLE SUBDIVISION OF USER INTERFACE ELEMENTS AND FULL-SCREEN ACCESS TO SUBDIVIDED ELEMENTS

(71) Applicant: SAP AG, Walldorf (DE)

(72) Inventors: Oliver Klemenz, Malsch (DE); Peter Eberlein, Hoffenheim (DE)

(73) Assignee: SAP AG, Walldorf (DE)

(21) Appl. No.: 13/711,598

(22) Filed: Dec. 11, 2012

(51) Int. Cl. G06F 3/01

(52) U.S. Cl. CPC G06F 3/017
USPC 715/765

(57) ABSTRACT

According to a method, while displaying a current user interface element on a touch screen of a multi-touch device, a gesture on the touch screen display that intersects the current user interface element is detected. In response to detecting the gesture, the current user interface element is reconfigured to have about half of its original size. A new user interface element is configured to have a size approximately equal to the reconfigured user interface element. The new user interface element and reconfigured current user interface element are displayed adjacent each other. The location of the gesture within the original user interface element can determine the proportions of the resulting reconfigured and new user interface elements. A pinch/unpinch gesture pair can configured for use in a binary mode as a “switch” to transition back and forth between displaying the user interface element at its current size and a predetermined enlarged size.

### BACKGROUND

This application relates to user interfaces, and in particular to configuring user interfaces for greater ease of use and effectiveness in communicating information.

Today's computer applications, whether they are being used for business applications, productivity, social networking or gaming, to name just a few, give rise to situations where users desire to make use of multiple user interface elements concurrently.

There are known ways to add new user interface elements, such as by clicking a tab to open a new browser window or right-clicking a mouse. These known ways are not necessarily intuitive to users, and some consume precious user interface area. In addition, neither of these known methods provides an adequate solution to a tablet user who may not have ready access to keyboard and/or mouse commands for creating new windows and executing other operations on windows, such as resizing them.

### SUMMARY

Described below are methods and apparatus that address the problems of the prior art.

An exemplary method comprises displaying a user interface on a touch screen of a multi-touch device, wherein the user interface comprises at least one current user interface element. While displaying the current user interface element, a gesture on the touch screen display that intersects the current user interface element is detected. In response to detecting the gesture, the current user interface element is reconfigured to have about half of its original size. A new user interface element is configured to have a size approximately equal to the reconfigured user interface element. The new user interface element is displayed adjacent the reconfigured current user interface element.

Detecting a gesture can comprise detecting a swipe gesture directed at least partially across the current user interface element. If the swipe gesture is detected to be in a generally top to bottom or bottom to top direction relative to the touch screen display, then the reconfigured user interface element and the new user interface element are displayed on the touch screen display adjacent each other in the side to side direction. If the swipe gesture is detected in a generally side to side direction relative to the touch screen display, then the reconfigured user interface element and the new user interface element are displayed on the touch screen display adjacent each other in the top to bottom or bottom to top direction.

A user interface element type chooser field for the new user interface element can be displayed. The method can comprise detecting user input to select a user interface element type for the new user interface element. If the user does not select a user interface type within a predetermined time interval, then the new user interface element is deleted and the reconfigured user interface element reverts to its original size.

A pinch gesture on the touch screen (or other suitable gesture) can be detected to trigger display of an adjacent one of the reconfigured current user interface element or the new user interface element at predetermined enlarged size to allow viewing the content thereof. An unpinch gesture on the touch screen (or other suitable gesture) can be detected to trigger display of the enlarged size user interface element at its former size.

According to another implementation, a portable electronic device comprises a touch screen display, at least one processor, a memory, one or more programs, wherein the one or more programs are stored in the memory and configured to be executed by the at least one processor. The one or more programs comprise instructions for displaying a user interface on the touch screen display, wherein the user interface comprises at least one current user interface element, instructions for detecting a gesture on the touch screen display associated with the current user interface element, instructions for reconfiguring the current user interface element into a reconfigured user element having a predetermined reduced size proportional to the location of the gesture, instructions for configuring a new user interface element to have a predetermined size proportional to the location of the gesture and together with reconfigured current user element making up the area of the current user interface element and instructions for displaying the new user interface element adjacent the reconfigured current user interface element.

### BRIEF DESCRIPTION OF THE DRAWINGS

FIG. 1 is a drawing illustrating an exemplary screen display showing a user interface with two user interface elements.

FIG. 2 is a drawing illustrating the screen display and user interface of FIG. 1 as a swipe gesture is being made across one of the user interface elements in a generally up-and-down direction.

FIG. 3 is a drawing illustrating the screen display after the original user interface element has been split into two, i.e., a reconfigured original user interface element and, positioned alongside, a new user interface element in which a user interface type chooser is displayed.

FIG. 4 is a drawing similar to FIG. 2, except the swipe gesture is directed in a generally side-to-side direction.

FIG. 5 is a drawing similar to FIG. 3, except the reconfigured original user interface element and the new user interface element are arranged adjacent each other in a generally up-and-down direction.

FIG. 6 is a drawing similar to FIG. 4, except the system is configured to detect a fraction of the original user interface element.

FIG. 7 is a drawing similar to FIGS. 3 and 5, except showing that the new user interface element is larger than the reconfigured original user interface element.

FIG. 8 is a drawing of the user interface of FIG. 3 in which the new user interface element is being expanded to a predetermined enlarged size in response to a unpinch gesture.

FIG. 9 is a drawing of the new user interface element of FIG. 8 displayed at the predetermined enlarged size and showing that an unpinch gesture has been detected to return the new user interface element to its former size as shown in FIG. 8.

FIG. 10 is a drawing of another user interface example for an application with multiple user interface elements that can be resized, repositioned and changed in content as desired.

FIG. 11 is a drawing of the user interface of FIG. 10 after one of the user interface elements has been subdivided.

FIG. 12 is a drawing of the user interface of FIG. 10 after another of the user interface elements has been subdivided.

FIG. 13 is a flow chart of an exemplary method of reconfiguring a user interface by subdividing user interface elements in response to predetermined gestures.

FIG. 14 is a system diagram of an exemplary mobile device.

FIG. 15 illustrates a generalized example of a suitable implementation environment in which describes embodiments, techniques and technologies may be implemented.

FIG. 16 is a block diagram showing another generalized example of a suitable computing environment.

### DETAILED DESCRIPTION

As used in this application and in the claims, the singular forms “a,” “an,” and “the” include the plural forms unless the context clearly dictates otherwise. Similarly, the word “or” is intended to include “and” unless the context clearly indicates otherwise. The term “comprising” means “including;” hence, “comprising A or B” means including A or B, as well as A and B together. Additionally, the term “includes” means “comprises.”

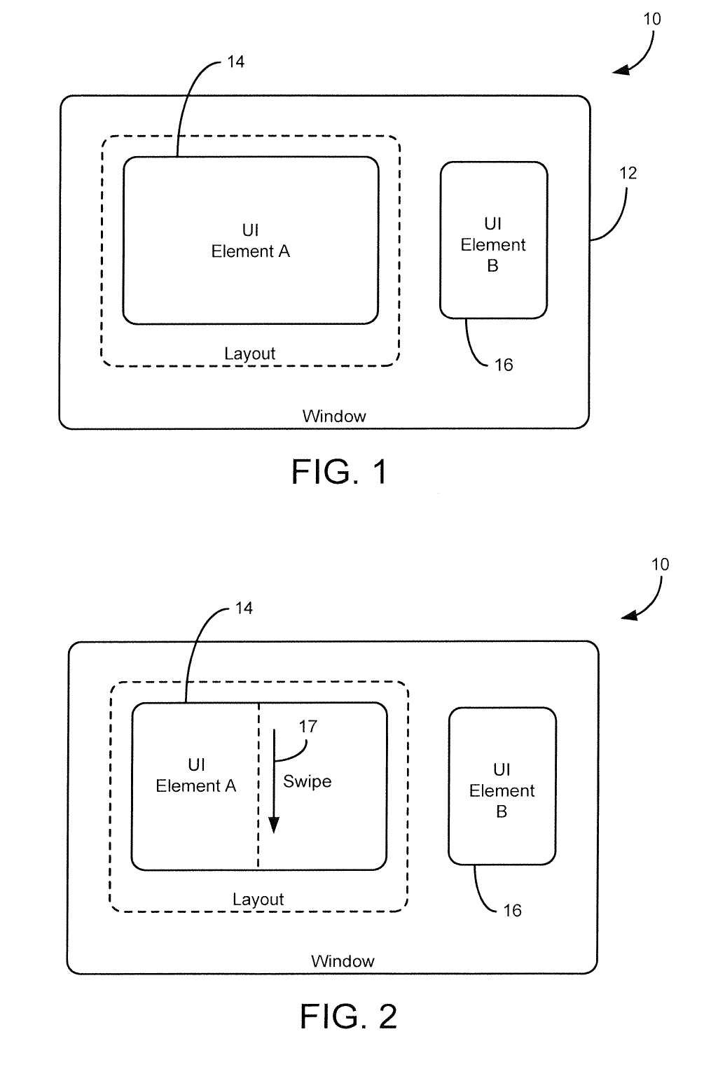

FIG. 1 is a drawing illustrating an exemplary display, such as a touch screen 10, of a mobile device or other computer showing a user interface 12 with at least a first user interface clement 14 (“UI Element A”) on the left side and a second user interface element 16 on the right side. For the user interface element 14, a dashed line border indicating “Layout” is also shown to indicate that the user interface elements can include spacing, margins, object padding, etc., in addition to an active window area. The user interface element can be a window, a view, a button, a toolbar, a tile or any other form of user interface element.

In FIG. 2, a swipe gesture, which is indicated at 17 by an arrow, has been executed on the surface of the touch screen 10 and over the displayed first user interface element 14. As used herein, performing a “swipe gesture” is understood to mean a user's act in contacting the touch screen 10 with a finger and, while maintaining contact with the touch screen, moving the finger in translation across the touch screen by at least a predetermined distance sufficient to indicate an intentional movement. Of course, it is possible to perform swipe gesture with other parts of the body and/or other objects. Moreover, a gesture other than a swipe gesture can be sued. In addition, similar motions made to execute operations on screen technologies that allow movements made near but not in contact with the screen to be recognized are also contemplated.

In FIG. 1, the exemplary touch screen 10 has a rectangular shape and is illustrated in a landscape orientation with its longer sides extending horizontally. As indicated, the swipe gesture 17 has been made in a generally up-and-down direction relative to the landscape orientation of the touch screen 10, i.e., approximately vertically. The indicated swipe gesture 17 is directed downwardly, but an upwardly directed gesture would be equivalent. As described below in greater detail, other gesture orientations are of course possible.

Although the swipe gesture 17 is shown within the user interface element 14, the system is preferably configured to detect a gesture that intersects a boundary of the interface element 14 as triggering the same operation. In other words, a downward swipe gesture beginning with a contact just above the displayed portion of the user interface element 14 but continuing downward into the displayed portion would also trigger the same operation as the displayed gesture.

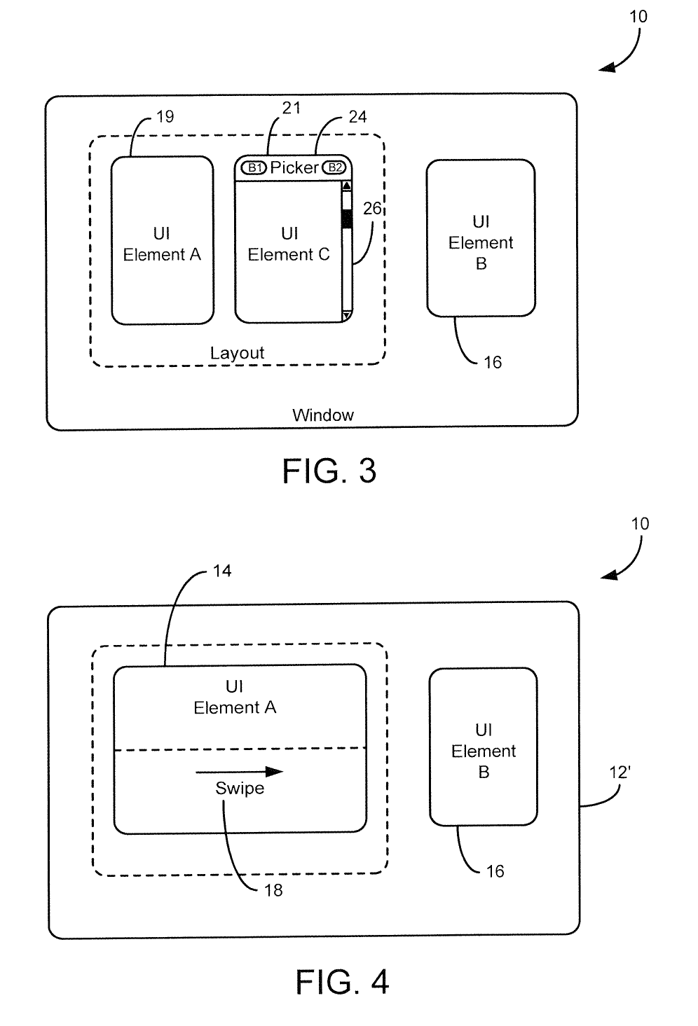

Following the swipe gesture 17 in FIG. 2, the user interface element 14 is “split into two,” as indicated in FIG. 3. More specifically, detection of the swipe gesture 17 made adjacent the first user interface element 14 (FIG. 2), also referred to as the “current user element,” causes it to be reconfigured from its original size into a reconfigured current user interface element 19 (FIG. 3). In addition a new user interface element 21 is caused to be displayed adjacent the reconfigured user interface element 19. In the example of FIG. 3, the user interface elements 19, 21 are displayed in a side-by-side relationship.

The user interface element 14 is “split into two” or “divided in half” or “cut in half” in the sense that the two resulting user interface elements 19, 21 each occupy approximately half of the area of the original user interface element 14. Because of the borders and margins, namely the center area separating the user interface elements 19, 21 from each other, their total visible area is slightly less than the visible area of the user interface element 14.

According to some implementations, the new user interface element 21 is configured to be of the same type as the user interface element 14/user interface element 19. According to other implementations, the user is given the option to specify a type of user interface for the new interface element 21. As indicated in FIG. 3, the user interface element 19 can have a “chooser window” or “picker window” 24 by which the user can select the type of user interface element for the new user interface element, including by using a scroll bar 26 as necessary to move through a list of possible user interface types. Further examples of the chooser window 24 are described below.

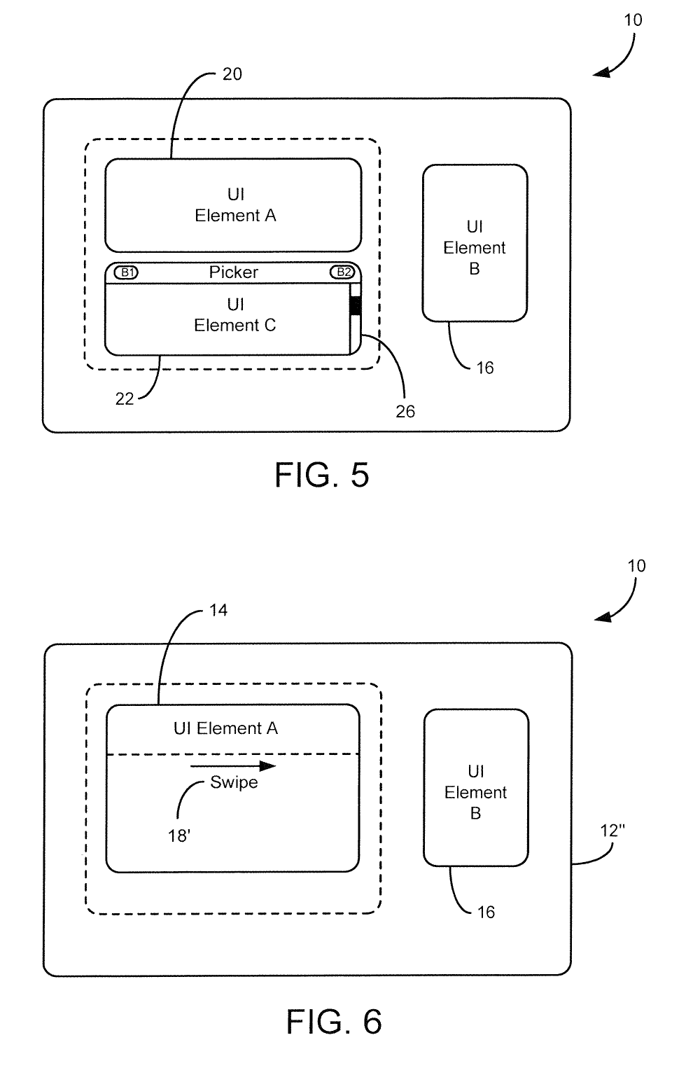

FIG. 4 is an example of another user interface 12′ displayed on the touch screen 10 in which the first user interface element 14 is being split into two by a swipe gesture 18 in a side-to-side direction (i.e., from left to right in the specific example of FIG. 4). As in the case of the swipe gesture 17, the direction of the gesture is generally aligned with the direction along which the first user element 14 is divided. As shown in FIG. 5, detection of the swipe gesture 18 made adjacent the first user interface element 14 (FIG. 4), causes it to be reconfigured from its original size into a reconfigured current user interface element 20 (FIG. 5). In addition, a new user interface element 22 is caused to be displayed adjacent the reconfigured user interface element 19. In the example of FIG. 5, the user interface elements 19, 21 are displayed in a top-to-bottom or vertically aligned relationship.

FIG. 6 is an example of another user interface 12″ in which a position of a swipe gesture 28 relative to the boundaries of the user interface element 14 is detected to determine relative sizes of the resulting user interface elements. Specifically, rather than having the resulting two user interface elements apportioned equally, in the implementation of FIG. 6, the user can choose to size one of the resulting user interface elements larger than the other by varying the location of where a swipe gesture 18″ is made. (In the other implementations described above, the system is configured to split the user interface element 14 into two predetermined equal sized user interface elements provided the swipe gesture is made within a predetermined area, and thus the swipe gesture need not be made in exactly the middle of the user interface element 14.)

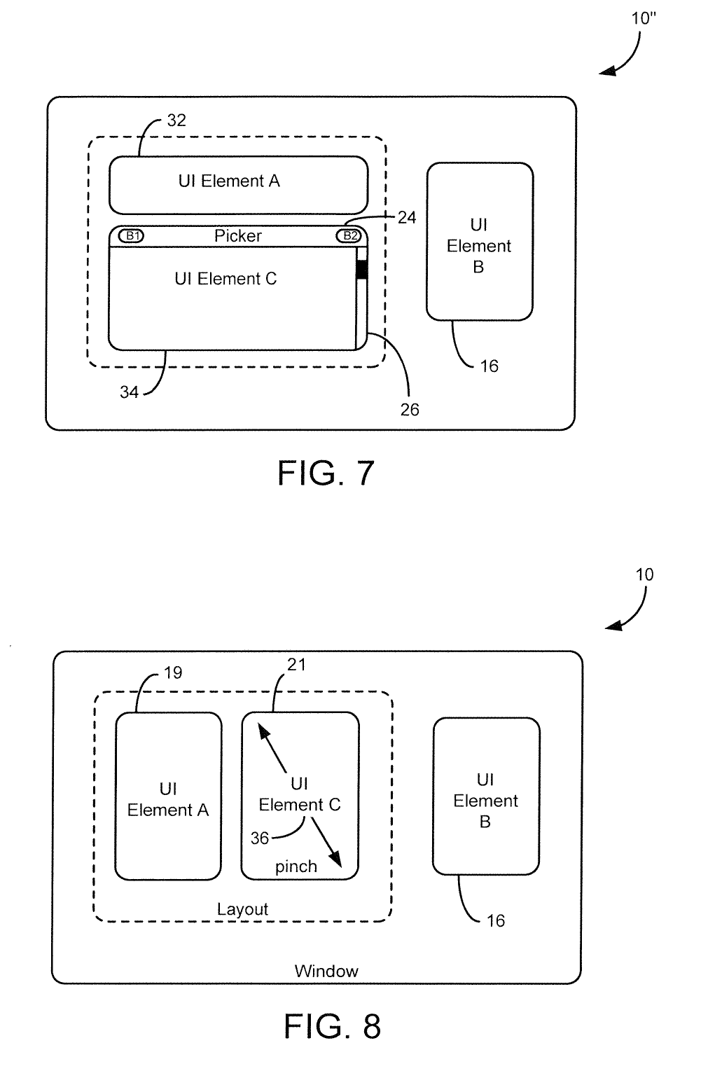

For example, in the implementation of FIG. 6, the swipe gesture 18″ is made at a position as shown, i.e., about one third of the distance from the top boundary to the bottom boundary, to divide the user interface element 14 into a smaller reconfigured user interface element 32 and a larger new user interface element 34 (FIG. 7). As shown in FIG. 7, the new user interface element 34 is about three times larger than the reconfigured user interface element 32.

In some implementations, a swipe gesture that intersects multiple user interface elements, which might be aligned in a row or in a column, is effective to split each intersected user interface element into two. Further, some implementations are configured to respond to multiple finger swipe gestures, such as by causing each user interface element intersected by a two-finger swipe gesture to split into two. That is, if a two-finger swipe gesture is performed from left to right over a column of two aligned user interface elements, the result can be dividing each of the two user interface elements to yield, e.g., a column of four aligned user interface elements. In some environments, a multi-finger gesture could be used to split a user interface element into more than two resulting elements in two directions, such as into four resulting elements if simultaneously split horizontally and vertically.

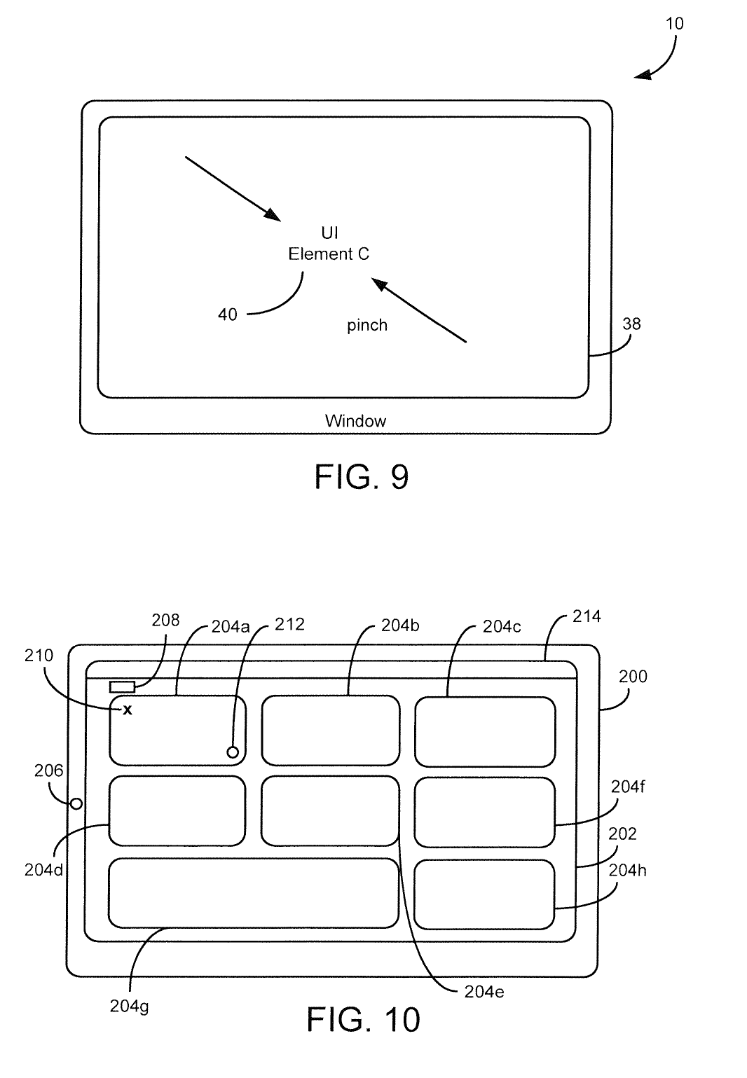

The user interface is also configured to respond to a pinch gesture in a predetermined way. As shown in FIGS. 8 and 9, a pinch gesture 36 detected on the new user interface element 21 causes that element to expand to a predetermined enlarged size user interface element 38. In the implementation of FIG. 9, the predetermined enlarged size user element 38 is full screen size. As also indicated in FIG. 9, an unpinch or “reverse pinch” gesture 40 can be used to return the enlarged size user element 38 to the size and position of the user interface element 21 in FIG. 8. In some implementations, the pinch and unpinch gestures are implemented in a binary mode, i.e., a pinch or an unpinch gesture of a predetermined minimum length is effective to cause the user interface element 21 to be increased to the enlarged size 38 or reduced from its enlarged size 38 to the smaller size of the user interface element 21, respectively, rather than causing an increase or decrease in scaled to the length of the gesture.

It is also possible to detect if the detected gesture would result in a new user interface element that would not meet a minimum size requirement for the system. In addition, the display of information within the user interface element can be set according to its size, e.g., such that a graphic is substituted for actual data if the resulting user interface element is too small to show the data in a meaningful form.

Although the above implementations show that the new user interface element is positioned adjacent the reconfigured original user interface element, e.g., either below it or alongside of it, having the new user interface element appearing at a predetermined set location, or in a stacked, tabbed or other associated relationship relative to the original user interface element is also possible.

FIG. 10 is a drawing showing a touch screen 200 with a user interface 202 comprising eight user interface elements 204a, 204b, 204c, 204d, 204e, 204f, 204g and 204h arranged in three rows and three columns. The touch screen 200 can have a hardware button 206, and the user interface can have any number of displayed buttons, such as a button 208 to toggle between “Edit” and “Done” modes. Each of the user interface elements can have a “Close” button and/or a “Settings” button (shown for the user interface element 204a as the buttons 210 and 212, respectively). An information bar 214 can be provided, and can display system or other information, including time of day, signal strength, carrier name, battery level etc.

Although other uses are of course possible, one suitable implementation for the user interface of FIG. 10 is a software application featuring highly configurable graphics content (e.g., charts, graphs, tables, lists, feeds lists, dynamic displays, etc.) which may be presented to a user as a dashboard for monitoring processes, organizations or other phenomena with changing conditions. The user interface is configured for use with a conventional tablet as the touch screen 200, but of course any touch screen or other type of display could be used.

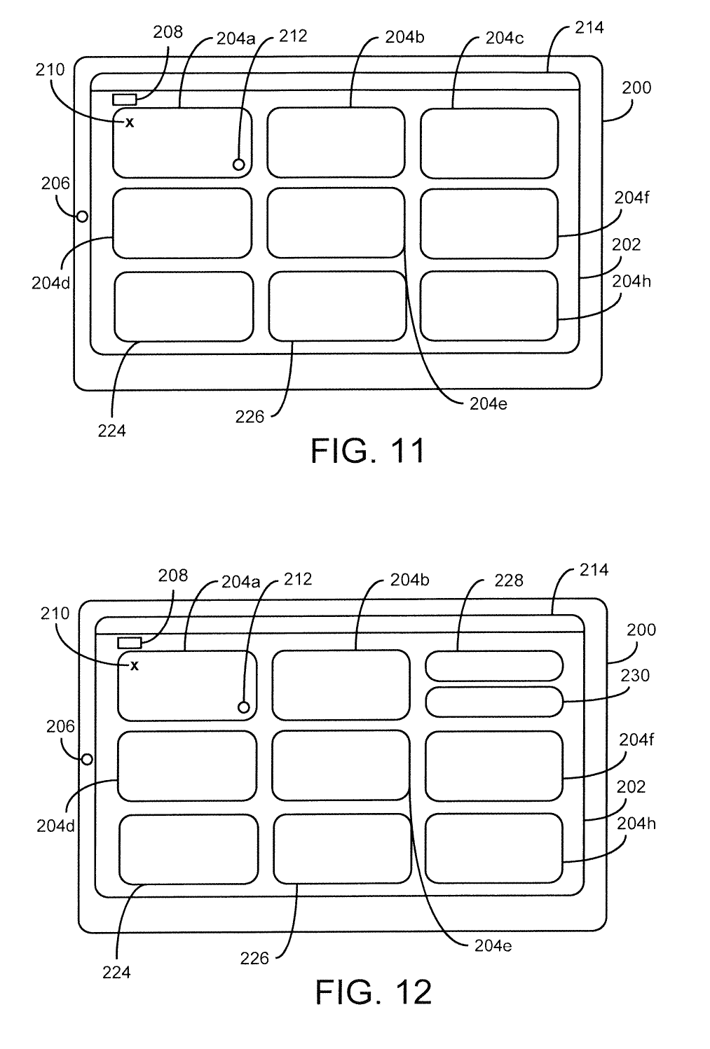

If a user to seeks to add another user interface element to the eight user interface elements currently displayed and filling the screen, then the user can, e.g., perform a swipe gesture in the up-and-down direction to slice the user interface element 204g into the user interface elements 224 and 226 as shown in FIG. 11. The content originally displayed in user interface element 204g is now displayed in the user interface 224. If desired, the system can be configured to default to displaying an icon or other representation for the actual content if any user interface element is at or below a predetermined minimum size. In this example, the new user interface element displays a chooser window 226 and a “Done” button (not shown). The chooser window displays a list of content choices from which a type of content can be chosen. If a choice is made, than the corresponding content is displayed and the swipe gesture routine is complete.

In some implementations, it is possible that the new user interface element will remain in a mode with the chooser window displayed, and the user will initiate other changes to the user interface, including a second swipe gesture. For example, the user can swipe from left to right along a path that intersects the left and/or right borders of the user interface element 204c, thereby triggering this user interface element to be split along the side-to-side direction with two resulting user interface elements aligned in the up-and-down direction. The resulting user interface elements 228, 230 are shown in FIG. 12.

The system can be configured to cause a new user interface element, such as the new user interface element 230, to be deleted if the user presses a “Close” button or if a predetermined time elapses without a specified action, e.g., if the user fails to choose a type in time. In some implementations, the user interface is configured such that if a new user interface element is deleted, then an adjacent user interface element “expands to fill the space” previously occupied by the new user interface element. For example, in FIG. 12 if the new interface element 230 is deleted, then the user interface element 228 will be expanded downwardly to fill the space previously occupied by the user interface element 230. Stated differently, in the example, the user interface element 228 will be reconfigured as original user interface element 204C.

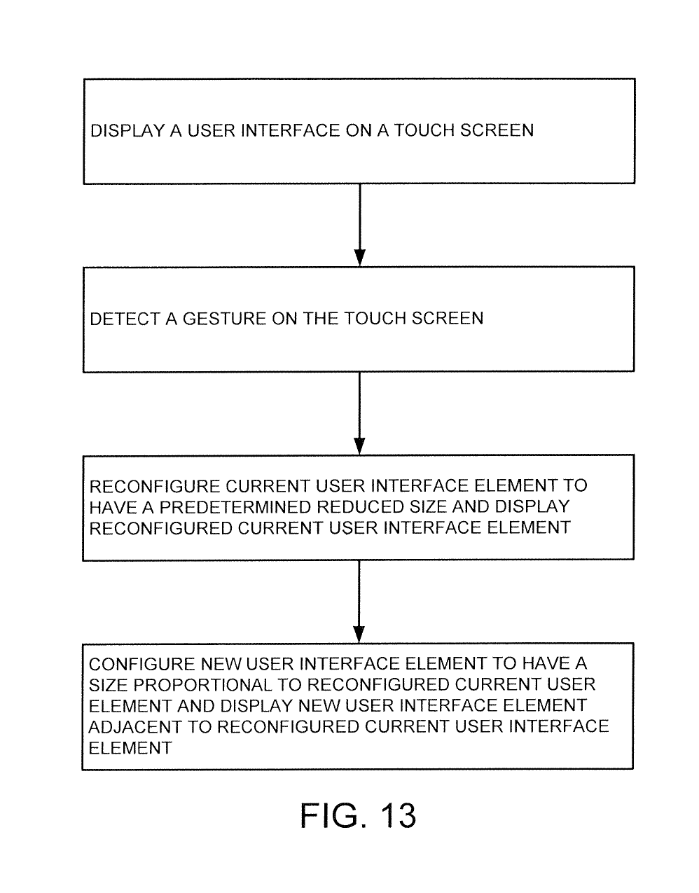

FIG. 13 is a flow chart of an exemplary process implemented. In step 300, a user interface is displayed on a touch screen. In step 302, it is assumed that an action has been taken to enter an Edit mode, which allows changes to the user interface to be made (if no such action is taken, then the current user interface continues to be displayed). For example, the user may have pressed an edit button (such as the button 208) or completed another assigned action, to enter the Edit mode.

While in Edit mode, the system detects whether any swipe gestures or other assigned gestures have been made. For example, in step 304, the system detects whether a swipe gesture made adjacent to user interface element and interprets the gesture as command to split the user interface element. If no swipe gesture or other assigned gesture is detected, then the system determines in step 306 whether the edit mode has been cancelled or timed out.

If not, in step 308, the user interface element is reconfigured to have a predetermined size (such as about half of its former size). In step 310, a new user interface element is created and configured to have a predetermined size. In some implementations, the new interface element is approximately the same size as the reconfigured user interface element. In other implementations, the user interface element has a size proportional to the location of the gesture within the boundaries of original user interface element (i.e., if the gesture divides the original user interface into a 75% portion and a 25% portion, then one resulting user interface element will be sized about three times larger than the other). In these implementations, the original user interface element can be configured to have a finite number of predetermined proportional divisions, e.g., ¼, ½, ¾, etc.

In some implementations, the new user interface element is pre-populated with the content of the original user interface element. In some implementations, the user is presented with a menu of user interface type or content options from which the type or content of the new user interface element can be chosen. The system can be configured such that if no input is received in time, then the new user interface element and the reconfigured user interface element are deleted and the original user interface element is redisplayed.

In some implementations, the editing of multiple user interface elements can occur concurrently. Thus, a first user interface elements may have been divided into a first two resulting user interface elements, and one of these first two resulting user interface elements may have been further divided into a second two resulting user interface elements before action was completed relative to the first two user interface elements (before the type of the new one of the first two resulting user interface elements has been selected).

In step 312, it is assumed that the user has exited the Edit mode. The user can exit the edit mode by pressing the button 208. In some implementations, the system will exit edit mode after a predetermined time out period. The user can then view and use the reconfigured user interface. As necessary, the user can enlarge and reduce the size of any selected user interface element, e.g., by using pinch and unpinch gestures.

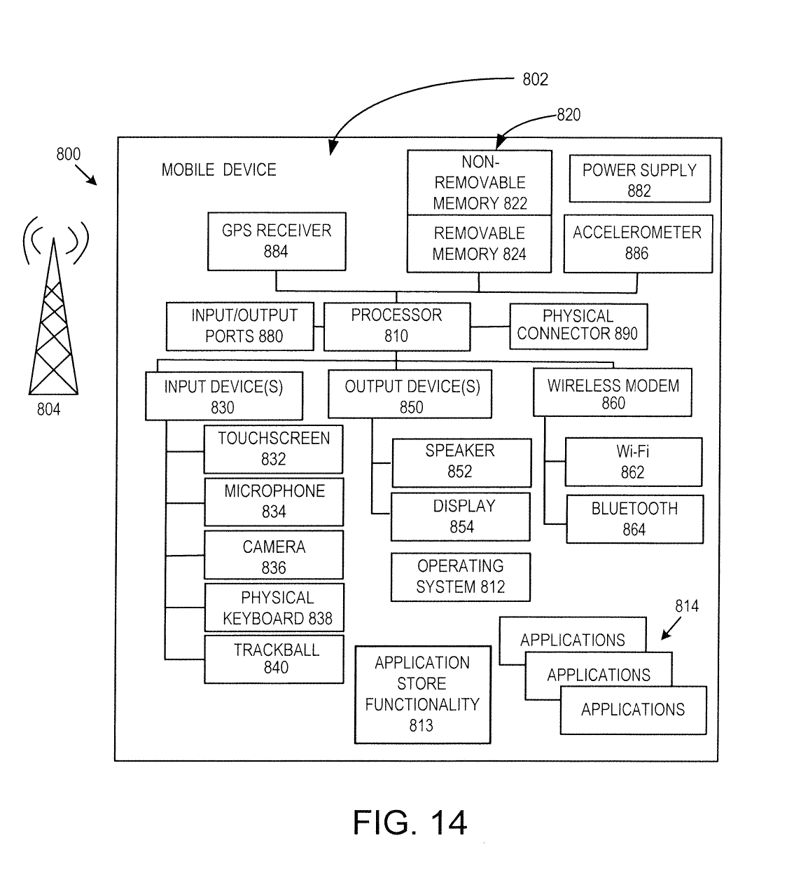

FIG. 14 is a system diagram depicting an exemplary mobile device 700 including a variety of optional hardware and software components, shown generally at 702. Any components 702 in the mobile device can communicate with any other component, although not all connections are shown, for ease of illustration. The mobile device can be any of a variety of computing devices (e.g., cell phone, smartphone, tablet, handheld computer, Personal Digital Assistant (PDA), etc.) and can allow wireless two-way communications with one or more mobile communications networks 704, such as a cellular or satellite network.

The illustrated mobile device 700 can include a controller or processor 710 (e.g., signal processor, microprocessor, ASIC, or other control and processing logic circuitry) for performing such tasks as signal coding, data processing, input/output processing, power control, and/or other functions. An operating system 712 can control the allocation and usage of the components 702 and support for one or more application programs 714 (“applications”). The application programs can include common mobile computing applications (e.g., email applications, calendars, contact managers, web browsers, messaging applications), or any other computing application, such as the dashboard application described above. Functionality 713 for accessing an application store can also be used for acquiring and updating applications 714.

The illustrated mobile device 700 can include memory 720. Memory 720 can include non-removable memory 722 and/or removable memory 724. The non-removable memory 722 can include RAM, ROM, flash memory, a hard disk, or other well-known memory storage technologies. The removable memory 724 can include flash memory or a Subscriber Identity Module (SIM) card, which is well known in GSM communication systems, or other well-known memory storage technologies, such as “smart cards.” The memory 720 can be used for storing data and/or code for running the operating system 712 and the applications 714. Example data can include web pages, text, images, sound files, video data, or other data sets to be sent to and/or received from one or more network servers or other devices via one or more wired or wireless networks. The memory 720 can be used to store a subscriber identifier, such as an International Mobile Subscriber Identity (IMSI), and an equipment identifier, such as an International Mobile Equipment Identifier (IMEI), which are transmitted to a network server to identify users and equipment.

The mobile device 700 can support one or more input devices 730, such as a touchscreen 732, microphone 734, camera 736, physical keyboard 738 and/or trackball 740 and one or more output devices 750, such as a speaker 752 and a display 754. Other possible output devices (not shown) can include piezoelectric or other haptic output devices. Some devices can serve more than one input/output function. For example, touchscreen 732 and display 754 can be combined in a single input/output device. The input devices 730 can include a Natural User Interface (NUI). An NUI is any interface technology that enables a user to interact with a device in a “natural” manner, free from artificial constraints imposed by input devices such as mice, keyboards, remote controls, and the like. Examples of NUI methods include those relying on speech recognition, touch and stylus recognition, gesture recognition both on screen and adjacent to the screen, air gestures, head and eye tracking, voice and speech, vision, touch, gestures, and machine intelligence. Other examples of a NUI include motion gesture detection using accelerometers/gyroscopes, facial recognition, 3D displays, head, eye, and gaze tracking, immersive augmented reality and virtual reality systems, all of which provide a more natural interface, as well as technologies for sensing brain activity using electric field sensing electrodes (EEG and related methods). Thus, in one specific example, the operating system 712 or applications 714 can comprise speech-recognition software as part of a voice user interface that allows a user to operate the device 700 via voice commands. Further, the device 700 can comprise input devices and software that allows for user interaction via a user's spatial gestures, such as detecting and interpreting gestures to provide input for controlling the device and reconfiguring the user interface as described above.

A wireless modem 760 can be coupled to an antenna (not shown) and can support two-way communications between the processor 710 and external devices, as is well understood in the art. The modem 760 is shown generically and can include a cellular modem for communicating with the mobile communication network 704 and/or other radio-based modems (e.g., Bluetooth 764 or Wi-Fi 762). The wireless modem 760 is typically configured for communication with one or more cellular networks, such as a GSM network for data and voice communications within a single cellular network, between cellular networks, or between the mobile device and a public switched telephone network (PSTN).

The mobile device can further include at least one input/output port 780, a power supply 782, a satellite navigation system receiver 784, such as a Global Positioning System (GPS) receiver, an accelerometer 786, and/or a physical connector 790, which can be a USB port, IEEE 1394 (FireWire) port, and/or RS-232 port. The illustrated components 702 are not required or all-inclusive, as any components can be deleted and other components can be added.

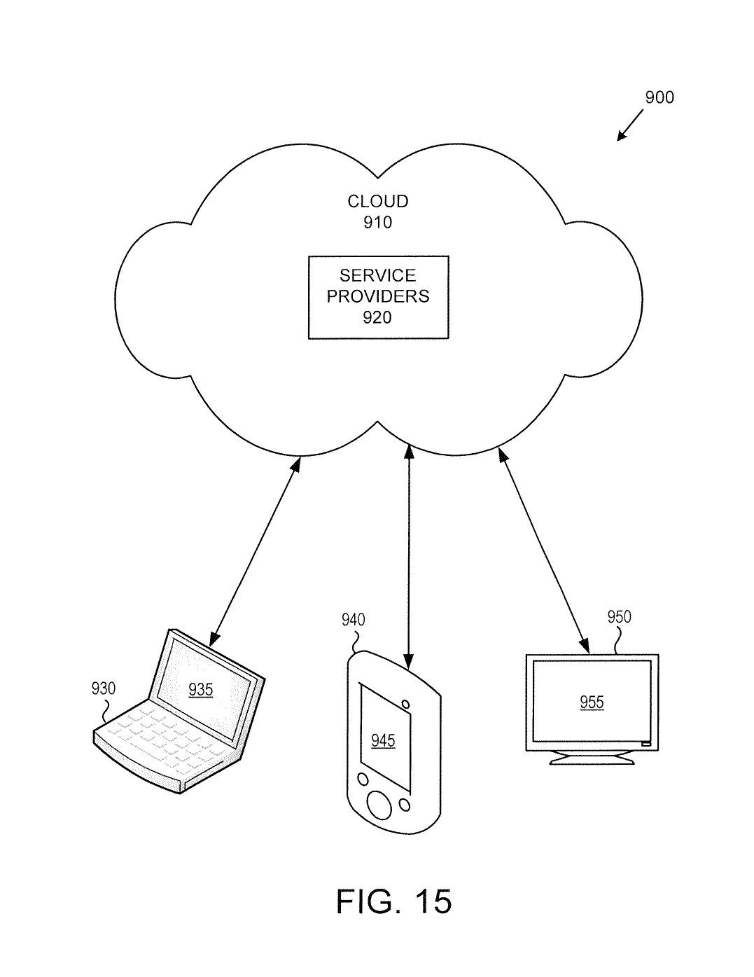

FIG. 15 illustrates a generalized example of a suitable implementation environment 800 in which described embodiments, techniques, and technologies may be implemented.

In example environment 800, various types of services (e.g., computing services) are provided by a cloud 810. For example, the cloud 810 can comprise a collection of computing devices, which may be located centrally or distributed, that provide cloud-based services to various types of users and devices connected via a network such as the Internet. The implementation environment 800 can be used in different ways to accomplish computing tasks. For example, some tasks (e.g., processing user input and presenting a user interface) can be performed on local computing devices (e.g., connected devices 830, 840, 850) while other tasks (e.g., storage of data to be used in subsequent processing) can be performed in the cloud 810.

In example environment 800, the cloud 810 provides services for connected devices 830, 840, 850 with a variety of screen capabilities. Connected device 830 represents a device with a computer screen 835 (e.g., a mid-size screen). For example, connected device 830 could be a personal computer such as desktop computer, laptop, notebook, netbook, or the like. Connected device 840 represents a device with a mobile device screen 845 (e.g., a small size screen). For example, connected device 840 could be a mobile phone, smart phone, personal digital assistant, tablet computer, or the like. Connected device 850 represents a device with a large screen 855. For example, connected device 850 could be a television screen (e.g., a smart television) or another device connected to a television (e.g., a set-top box or gaming console) or the like. One or more of the connected devices 830, 840, 850 can include touchscreen capabilities. Touchscreens can accept input in different ways. For example, capacitive touchscreens detect touch input when an object (e.g., a fingertip or stylus) distorts or interrupts an electrical current running across the surface. As another example, touchscreens can use optical sensors to detect touch input when beams from the optical sensors are interrupted. Physical contact with the surface of the screen is not necessary for input to be detected by some touchscreens. Devices without screen capabilities also can be used in example environment 800. For example, the cloud 810 can provide services for one or more computers (e.g., server computers) without displays.

Services can be provided by the cloud 810 through service providers 820, or through other providers of online services (not depicted). For example, cloud services can be customized to the screen size, display capability, and/or touchscreen capability of a particular connected device (e.g., connected devices 830, 840, 850).

In example environment 800, the cloud 810 provides the technologies and solutions described herein to the various connected devices 830, 840, 850 using, at least in part, the service providers 820. For example, the service providers 820 can provide a centralized solution for various cloud-based services. The service providers 820 can manage service subscriptions for users and/or devices (e.g., for the connected devices 830, 840, 850 and/or their respective users).

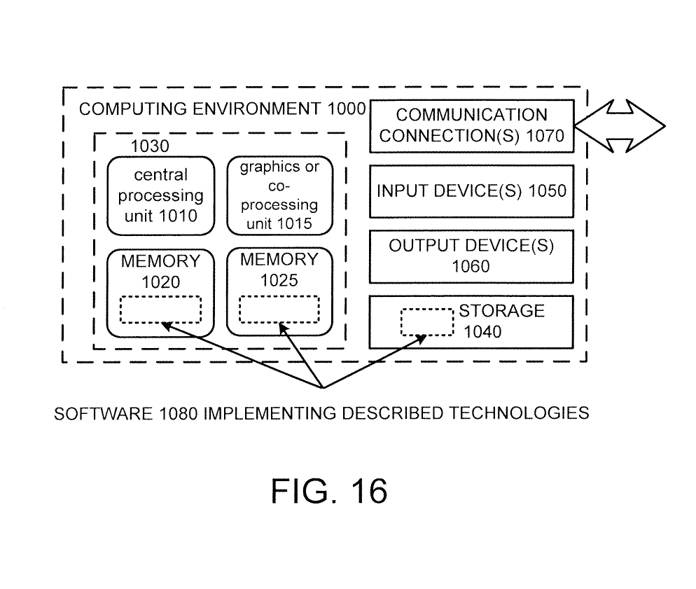

FIG. 16 depicts a generalized example of a suitable computing environment 900 in which the described innovations may be implemented. The computing environment 900 is not intended to suggest any limitation as to scope of use or functionality, as the innovations may be implemented in diverse general-purpose or special-purpose computing systems. For example, the computing environment 900 can be any of a variety of computing devices (e.g., desktop computer, laptop computer, server computer, tablet computer, media player, gaming system, mobile device, etc.).

With reference to FIG. 16, the computing environment 900 includes one or more processing units 910, 915 and memory 920, 925. In FIG. 16, this basic configuration 930 is included within a dashed line. The processing units 910, 915 execute computer-executable instructions. A processing unit can be a general-purpose central processing unit (CPU), processor in an application-specific integrated circuit (ASIC) or any other type of processor. In a multi-processing system, multiple processing units execute computer-executable instructions to increase processing power. For example, FIG. 16 shows a central processing unit 910 as well as a graphics processing unit or co-processing unit 915. The tangible memory 920, 925 may be volatile memory (e.g., registers, cache, RAM), non-volatile memory (e.g., ROM, EEPROM, flash memory, etc.), or some combination of the two, accessible by the processing unit(s). The memory 920, 925 stores software 980 implementing one or more innovations described herein, in the form of computer-executable instructions suitable for execution by the processing unit(s).

A computing system may have additional features. For example, the computing environment 900 includes storage 940, one or more input devices 950, one or more output devices 960, and one or more communication connections 970. An interconnection mechanism (not shown) such as a bus, controller, or network interconnects the components of the computing environment 900. Typically, operating system software (not shown) provides an operating environment for other software executing in the computing environment 900, and coordinates activities of the components of the computing environment 900.

The tangible storage 940 may be removable or non-removable, and includes magnetic disks, magnetic tapes or cassettes, CD-ROMs, DVDs, or any other medium which can be used to store information in a non-transitory way and which can be accessed within the computing environment 900. The storage 940 stores instructions for the software 980 implementing one or more innovations described herein.

The input device(s) 950 may be a touch input device such as a keyboard, mouse, pen, or trackball, a voice input device, a scanning device, or another device that provides input to the computing environment 900. For video encoding, the input device(s) 950 may be a camera, video card, TV tuner card, or similar device that accepts video input in analog or digital form, or a CD-ROM or CD-RW that reads video samples into the computing environment 900. The output device(s) 960 may be a display, printer, speaker, CD-writer, or another device that provides output from the computing environment 900.

The communication connection(s) 970 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the figures may not show the various ways in which the disclosed methods can be used in conjunction with other methods.

Any of the disclosed methods can be implemented as computer-executable instructions stored on one or more computer-readable storage media (e.g., non-transitory computer-readable media, such as one or more optical media discs, volatile memory components (such as DRAM or SRAM), or nonvolatile memory components (such as flash memory or hard drives)) and executed on a computer (e.g., any commercially available computer, including smart phones or other mobile devices that include computing hardware). As should be readily understood, the term computer-readable storage media does not include communication connections, such as modulated data signals. Any of the computer-executable instructions for implementing the disclosed techniques as well as any data created and used during implementation of the disclosed embodiments can be stored on one or more computer-readable media (e.g., non-transitory computer-readable media, which excludes propagated signals). The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

It should also be well understood that any functionality described herein can be performed, at least in part, by one or more hardware logic components, instead of software. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. A method, comprising:
displaying a user interface on a touch screen of a multi-touch device, wherein the user interface comprises at least one current user interface element;
while displaying the current user interface element, detecting a gesture on the touch screen display that intersects the current user interface element; and
in response to detecting the gesture, reconfiguring the current user interface element to have about half of its original size and displaying a reconfigured current user interface element;
configuring a new user interface element to have a size approximately equal to the reconfigured user interface element and displaying the new user interface element adjacent the reconfigured current user interface element.

2. The method of claim 1, wherein detecting a gesture comprises detecting a swipe gesture directed at least partially across the current user interface element.

3. The method of claim 2, wherein the swipe gesture is detected to be in a generally top to bottom or bottom to top direction relative to the touch screen display, and wherein the reconfigured user interface element and the new user interface element are displayed on the touch screen display adjacent each other in the side to side direction.

4. The method of claim 2, wherein the swipe gesture is detected in a generally side to side direction relative to the touch screen display, and wherein the reconfigured user interface element and the new user interface element are displayed on the touch screen display adjacent each other in the top to bottom or bottom to top direction.

5. The method of claim 1, further comprising a displaying a user interface element type chooser field for the new user interface element.

6. The method of claim 5, further comprising detecting user input to select a user interface element type for the new user interface element.

7. The method of claim 5, wherein if the user does not select a user interface type within a predetermined time interval the new user interface element is deleted and the reconfigured user interface element reverts to its original size.

8. The method of claim 1, further comprising detecting a pinch gesture on the touch screen and triggering display of an adjacent one of the reconfigured current user interface element or the new user interface element at predetermined enlarged size to allow-viewing the content thereof.

9. The method of claim 8, further comprising detecting an unpinch gesture on the touch screen and triggering display of the enlarged size user interface element at its former size.

10. A portable electronic device, comprising:
a touch screen display;
at least one processor;
a memory;
one or more programs, wherein the one or more programs are stored in the memory and configured to be executed by the at least one processor, the one or more programs comprising:
instructions for displaying a user interface on the touch screen display, wherein the user interface comprises at least one current user interface element;
instructions for detecting a gesture on the touch screen display associated with the current user interface element;
instructions for reconfiguring the current user interface element into a reconfigured user element having a predetermined reduced size proportional to the location of the gesture;
instructions for configuring a new user interface element to have a predetermined size proportional to the location of the gesture and together with reconfigured current user element making up the area of the current user interface element; and
instructions for displaying the new user interface element adjacent the reconfigured current user interface element.

11. The device of claim 10, wherein the detected gesture comprises a swipe gesture directed at least partially across the current user interface element.

12. The device of claim 11, wherein the swipe gesture is detected in a generally top to bottom or bottom to top direction relative to the touch screen display, and wherein the reconfigured user interface element and the new user interface element are displayed on the touch screen display adjacent each other in the side to side direction.

13. The device of claim 11, wherein the swipe gesture is detected in a generally side to side direction relative to the touch screen display, and wherein the reconfigured user interface element and the new user interface element are displayed on the touch screen display adjacent each other in the top to bottom or bottom to top direction.

14. The device of claim 10, wherein the predetermined reduced size of the current user interface element is about 50% of its original size, and wherein the predetermined size of the new user interface element is approximately equal to the reduced size of the current user interface element.

15. The device of claim 10, wherein the instructions for detecting a gesture comprise instructions for detecting a predetermined touch contact and subsequent motion pattern made by a user.

16. The device of claim 10, wherein the one or more programs comprise instructions for displaying a user interface element type chooser field for the new user interface element.

17. The device of claim 10, wherein the one or more programs comprise instructions for detecting a user input to select a user interface element type for the new user interface element.

18. The device of claim 10, wherein the one or more programs comprise instructions for determining whether the current user interface element at the predetermined reduced size is at least as large as a minimum required size for a user interface element.

19. The device of claim 10, wherein the one or more programs further comprise instructions for displaying the reconfigured current user interface element or the new user interface element at a predetermined enlarged size to allow viewing the content thereof in response to a pinch gesture.

20. The device of claim 19, wherein the one or more programs comprise instructions for causing a user interface element displayed at a predetermined enlarged size to revert to its previous size in response to an unpinch gesture detected adjacent the user interface element.
